(19) United States
(12) Patent Application Publication
(10) Pub. No.: US 2015/0261431 A1
(43) Pub. Date: Sep. 17, 2015

(54) INFORMATION TERMINAL

(71) Applicant: SHARP KABUSHIKI KAISHA, Osaka-shi, Osaka (JP)

(72) Inventors: Kiyofumi Ohtsuka, Osaka-shi (JP); Hirokazu Ishikawa, Osaka-shi (JP); Yoshichika Iida, Osaka-shi (JP); Takaaki Mitsunaga, Osaka-shi (JP); Tadao Andou, Osaka-shi (JP); Megumi Yokogawa, Osaka-shi (JP)

(73) Assignee: Sharp Kabushiki Kaisha, Osaka-shi, Osaka (JP)

(21) Appl. No.: 14/437,222

(22) PCT Filed: Feb. 19, 2014
(86) PCT No.: PCT/JP2014/053933

§ 371 Date: Apr. 21, 2015

(30) Foreign Application Priority Data
Feb. 27, 2013 (JP) 2013-037918
Jun. 20, 2013 (JP) 2013-129907

(51) Int. Cl. G06F 3/0488; G06F 3/0486; G06F 3/0484; G06F 3/0485; G06F 3/041; G06F 3/0489

(52) U.S. Cl. CPC G06F 3/04886; G06F 3/0412; G06F 3/0489; G06F 3/04845; G06F 3/04842; G06F 3/0485; G06F 3/0486; G06F 2203/04101; G06F 2203/04104; G06F 2203/04801; G06F 2203/04803; G06F 2203/04804; G06F 2203/04808

(57) ABSTRACT

The present invention allows a software keyboard and an application in execution to coexist. The present invention includes a display area setting section (31). In a case where (i) it is detected that the software keyboard is activated by a first application and (ii) it is determined that a second application is being executed, the display area setting section (31) changes a display area and a display position of the second application so that an operation to the software keyboard is not disturbed.

### TECHNICAL FIELD

The present invention relates to an information terminal capable of executing an application in which a software keyboard function is used. The software keyboard function is for inputting characters and displays an image of a keyboard on a screen.

### BACKGROUND ART

A conventional mobile information terminal such as a mobile phone was provided with many hardware keys such as a numeric keypad and a dial key. However, nowadays, a screen size of a mobile information terminal tends to be increased as much as possible. On this account, there are a large number of types of mobile information terminals whose one surface is substantially entirely a display screen so that a screen size of such a mobile information terminal is increased as much as possible without increasing a size of the mobile information terminal itself.

In such a mobile information terminal, an operation input and a character input are received, by displaying an image of an operation button or a keyboard, or the like, on the display screen (software keyboard).

Meanwhile, in accordance with an increase in size of the display screen, there are many types of mobile information terminals that are capable of executing a plurality of applications on a screen.

For example, Patent Literature 1 discloses a mobile information terminal in which: a display screen is divided; and in individual screen areas of thus divided screen, different applications are concurrently executed. Patent Literature 1 further describes (i) an operation to an application displayed in the individual screen area is carried out, and (ii) a method that makes it possible to share information between different applications by carrying out a touch operation over any two or more of the individual display areas.

### CITATION LIST

### Patent Literature 1

Japanese Translation of PCT International Publication

Tokuhyo No. 2012-521595 (Publication date: Sep. 13, 2012)

### SUMMARY OF INVENTION

### Technical Problem

In the above software keyboard, it is desirable to arrange each key area to have a size that allows each key to be easily touched so that an erroneous operation is prevented. It is also desirable to display as many keys as possible so that the number of times that keys are touched is reduced.

In a case where a software keyboard is displayed in view of the above, substantially a half area of a display screen is occupied by the software keyboard.

Then, when the software keyboard is displayed while a plurality of applications are being executed on the display screen, display of the applications being executed may be disturbed by the software keyboard displayed, or conversely, an operation to the software keyboard may be disturbed by the display of the applications.

Paten Literature 1 does not mention such an adverse effects caused by the display of the software keyboard in the invention of Paten Literature 1.

The present invention is attained in view of the above problems. An object of the present invention is to provide an information terminal or the like in which a software keyboard and an application being executed can coexist.

### Solution to Problem

In order to solve the above problems, an information terminal according to one aspect of the present invention is an information terminal capable of concurrently executing a plurality of applications in a display section, the information terminal including: a software keyboard detecting section for detecting that a software keyboard is activated by a first application in which characters are inputted through the software keyboard; an application determination section for determining whether or not a second application different from the first application is being executed, in a case where the software keyboard detecting section detects that the software keyboard is activated; and an application display control section for changing a display area of the second application so that the display area of the second application does not disturb an operation to the software keyboard, in a case where the application determination section determines that the second application is being executed.

### Advantageous Effects of Invention

According to one aspect of the present invention, a display area of a second application does not disturb an operation to a software keyboard. This configuration allows a user to easily make an operation to the software keyboard. The above configuration also makes it possible to prevent a user from missing what is displayed by the second application, because display of the second application is continued.

### BRIEF DESCRIPTION OF DRAWINGS

FIG. 1 is a block diagram illustrating a schematic configuration of a mobile terminal according to Embodiment 1 of the present invention.

FIG. 2 is a diagram illustrating an appearance of the above mobile terminal.

FIG. 3 is a flowchart illustrating a processing flow in the above mobile terminal.

FIG. 4 is a diagram illustrating a display example in processing in the above mobile terminal.

FIG. 5 is a diagram illustrating a display example in processing in a mobile terminal according to Embodiment 2 of the present invention.

FIG. 6 is a diagram illustrating a display example in processing in a mobile terminal according to Embodiment 3 of the present invention.

FIG. 7 is a diagram illustrating a display example in a modified example of the present invention.

FIG. 8 is a block diagram illustrating a configuration of a mobile terminal according to Embodiment 4 of the present invention.

FIG. 9 is a diagram illustrating a display-transition example in a display section of the above mobile terminal.

FIG. 10 is a flowchart illustrating a processing flow in the above mobile terminal.

FIG. 11 is a diagram illustrating another display-transition example in the display section of the above mobile terminal.

FIG. 12 is a diagram illustrating still another display-transition example in the display section of the above mobile terminal.

### DESCRIPTION OF EMBODIMENTS

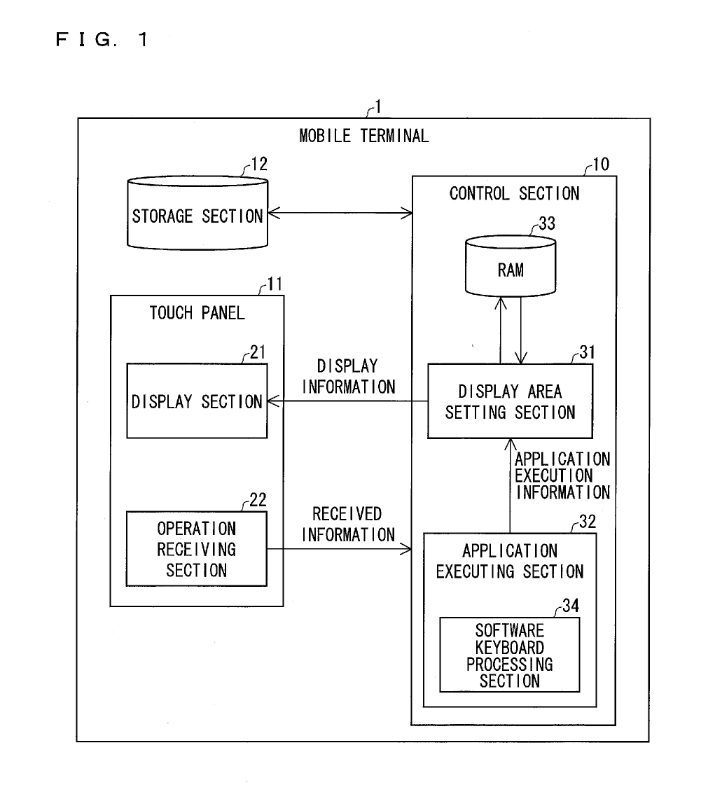

The following discusses embodiments of the present invention with reference to FIGS. 1 to 12. Descriptions of configurations except for configurations discussed in each specific embodiment below may be omitted as necessary. In a case where any of such configurations whose descriptions are omitted is described in another embodiment, the configuration whose description is omitted is the same as that described in the another embodiment. Furthermore, for convenience of explanation, members respectively having identical functions in embodiments are given the same reference signs, and explanations thereof are omitted as appropriate.

### Embodiment 1

The following discusses Embodiment 1 of the present invention in detail, with reference to FIGS. 1 to 4. In Embodiment 1, an upper direction of a mobile terminal 1 herein is a direction of an upper side of the mobile terminal 1 at the time when the mobile terminal 1 is held by a user so as to have a longitudinal side along a vertical direction. Meanwhile, a right direction of the mobile terminal 1 herein means a direction of the user's right side on a touch panel 11 of the mobile terminal 1 at the time when the mobile terminal 1 is held by a user so as to have a longitudinal side along a vertical direction.

[1. Configuration of Device]

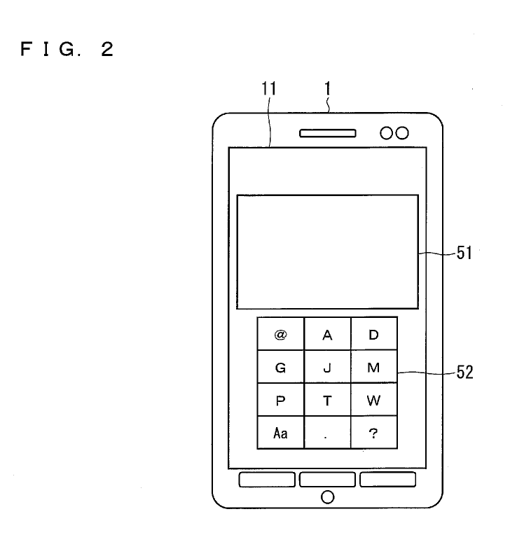

FIG. 2 illustrates an appearance of a mobile terminal (information terminal) 1 according to Embodiment 1. Here, the mobile terminal 1 is assumed to be a smartphone. However, the mobile terminal 1 is not limited to a smartphone but can be, for example, a mobile phone, a laptop PC (Personal Computer), or the like.

As illustrated in FIG. 2, the mobile terminal 1 includes a touch panel 11. The mobile terminal 1 is operated by contacting or approaching a finger, a pen, or the like to the touch panel 11. FIG. 2 illustrates a state in which (i) a software keyboard is activated and (ii) a character input area 51 and a software keyboard 52 are being displayed on the touch panel 11.

Next, the following discusses a schematic configuration of the mobile terminal 1, with reference to FIG. 1. FIG. 1 is a block diagram illustrating a schematic configuration of the mobile terminal 1 according to Embodiment 1 of the present invention.

As illustrated in FIG. 1, the mobile terminal 1 is configured to include a control section 10, the touch panel 11, and a storage section 12. Note that, FIG. 1 illustrates a configuration related to display processing of the software keyboard among various configurations of the mobile terminal 1. Other configurations of the mobile terminal 1 are the same as those of a conventional mobile terminal, and therefore, descriptions thereof are omitted herein.

The software keyboard is an image of a keyboard displayed in a display section. Then, when thus displayed keyboard image is touched, the software keyboard carries out, in accordance with a touched position, processing that is the same as processing in a case where a corresponding position of an actual keyboard is depressed.

The touch panel 11 includes a display section 21 and an operation receiving section 22. The display section 21 displays an image on a display screen, in accordance with display information received from the control section 10. The display section 21 is an LCD (Liquid Crystal Display), an EL (Electroluminescence) display, or the like, and configured to include display elements, and a driver circuit for driving the display elements in accordance with received image data.

The operation receiving section 22 is provided either on the display screen of the display section 21 or integrally formed with the display screen. The operation receiving section 22 receives an operation to the mobile terminal 1, by detecting a position to which a pointer, such as a user's finger or a pen, which indicates a position on the display screen, touches or approaches (hereinafter, referred to as “touch”) on the display screen. The operation receiving section 22 transmits, to the control section 10, received information that is information on a position where a touch is detected.

Note that, in Embodiment 1, an area in which the display section 21 displays an image is the same as an area where the operation receiving section 22 detects an operation.

The control section 10 carries out overall control of each configuration in the mobile terminal 1, and includes a processor such as a CPU (Central Processing Unit). The storage section 12 stores various data and programs and includes a storage element such as a RAM (Random Access Memory), a ROM (Read Only Memory), a flash memory and/or the like.

The following further discusses the control section 10 in detail. The control section 10 includes a display area setting section (software keyboard detecting section, application determination section, and application display control section) 31, an application executing section 32, and a RAM 33. The application executing section 32 includes a software keyboard processing section 34.

In a case where, while two applications are being executed, processing for activating a software keyboard is carried out by either one of the two applications, the display area setting section 31 (i) sets a display area and a display position of the other application so that an operation to the software keyboard is not disturbed, and then (ii) notifies display information to the display section 21 so that the other application is displayed in accordance with the display area and the display position which are set as described above. The display area setting section 31 also (iii) stores, in the RAM 33, a display area and a display position of the other application before the above change and then (iv) notifies display information to the display section 21 so that, when processing of the software keyboard ends, the other application is displayed again in accordance with the display area and the display position before the change. Note that a processing flow of setting a display area and a display position of an application will be discussed later.

The display area setting section 31 also sets a display area and a display position of an application in accordance with application execution information that has been notified from the application executing section 32, and then notifies, as display information, information for executing the application to the display section 21. This information for executing the application contains the display area and the display position that are set as above. Furthermore, in a case where the application execution information notified from the application executing section indicates that a plurality of applications are being executed, the display area setting section 31 appropriately sets a display area and a display position for each of the plurality of applications, and then notifies, as display information, information on the display area and the display position to the display section 21. The display area setting section 31 also stores, in the RAM 33, information indicative of the display area and the display position that are set as described above.

The application executing section 32 processes various applications that are to be executed in the mobile terminal 1. Execution processing of the various applications can be carried out by a conventional technique, and therefore, descriptions thereof are omitted.

The software keyboard processing section 34 carries out processing related to the software keyboard.

The RAM 33 is caused to temporarily store a display area, a display position, etc. which are set by the display area setting section 31.

[2. Processing Flow]

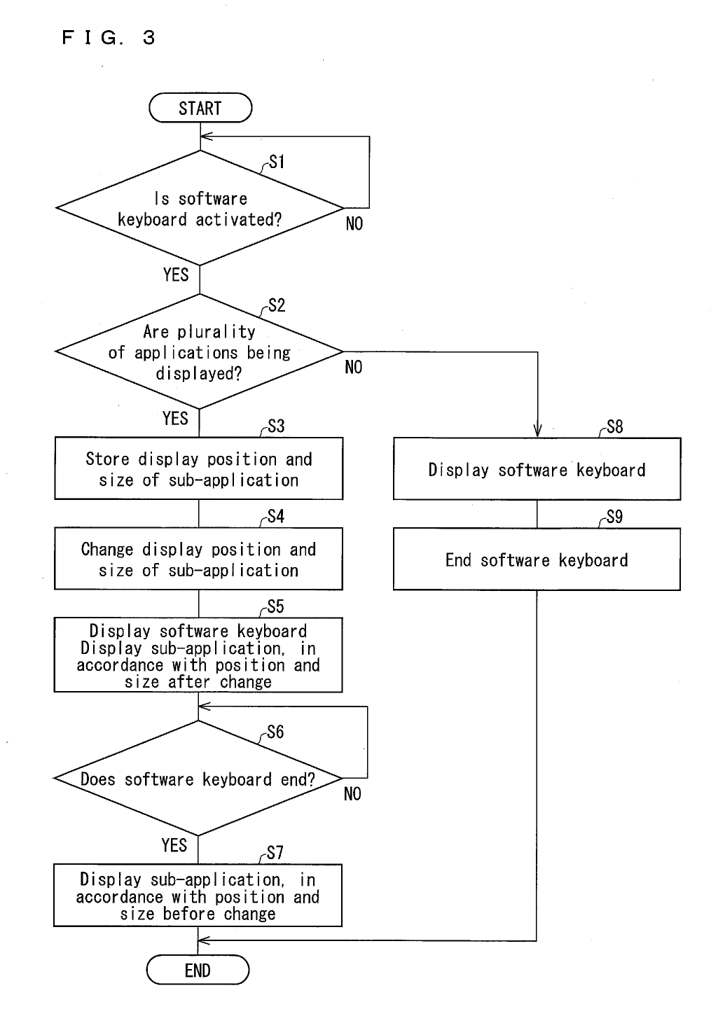

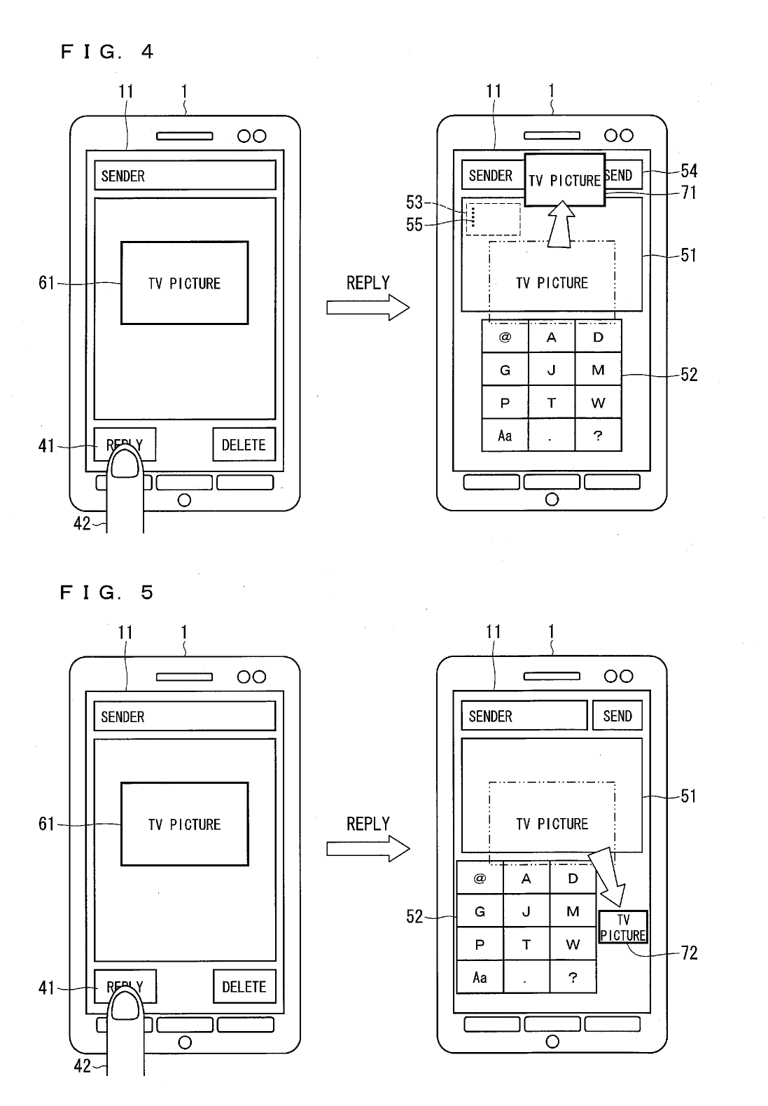

Next, the following discusses a processing flow for changing a display area and a display position of an application in the mobile terminal 1, with reference to FIGS. 3 and 4. FIG. 3 is a flowchart illustrating the processing flow for changing a display area and a display position of an application. FIG. 3 is a diagram illustrating a display example of a case where a display area and a display position of a sub-application are to be changed. The term “sub-application” means an application that is different from an application by which a software keyboard is activated.

As illustrated in FIG. 2, when the software keyboard processing section 34 activates a software keyboard (YES at 51), the application executing section 32 notifies the display area setting section 31 of application execution information which indicates that the software keyboard is activated. The software keyboard is activated, for example, when an instruction to create an email is received while an email application is being executed.

The display area setting section 31 having been notified of activation of the software keyboard determines whether or not a plurality of applications are being displayed (S2). In a case where the plurality of applications are being executed (YES at S2), the display area setting section 31 stores, in the RAM 33, a display area and a display position of a sub-application. The term “a sub-application” as used here means an application that is different from an application by which the software keyboard has been activated.

Next, the display area setting section 31 changes the display area and the display position of the sub-application (S4), and then notifies display information to the display section 21 (S5) so that the sub-application is displayed in the display section 21 in accordance with the display area and the display size after the above change.

The following discusses an example of changing the display area and the display position of the sub-application, with reference to FIG. 4. FIG. 4 illustrates an example case where, while an email application and a television application are being activated, a software keyboard is activated by the email application.

A left diagram of FIG. 4 illustrates a state in which the email application and the television application are concurrently activated and an image of a television 61 is displayed so as to overlap with an email receiving screen. In such a state, the software keyboard is activated (right diagram of FIG. 4) when a reply button 41 of the email application is depressed with a finger 42 or the like. As illustrated in the right diagram of FIG. 4, after the software keyboard is activated, a character input area 51 and a software keyboard 52 are displayed. Concurrently with display of the character input area 51 and the software keyboard 52, a display position of the television application which is the sub-application is moved to a position that is slightly right to an upper center of the display section 21. At the same time, a display area of the sub-application is reduced to substantially a half of an original display area of the sub-application.

At this time, the display position of the television application overlaps with neither a character input position 53 of the character input area 51 nor the software keyboard 52 nor a send button 54. Further, the display area of the television application still has a size that does not make it difficult to watch television. In Embodiment 1, a television application display area 71 and the character input area 51 slightly overlap with each other. This is because, in a case where the television application display area 71 is set so as not to overlap with the character input area 51 at all, a display size of the television application display area 71 becomes so small that it becomes difficult to watch television.

Therefore, an operation to the software keyboard is not disturbed by television being displayed. This allows a user to concurrently (i) watch television and (ii) operate the software keyboard. Accordingly, this allows preventing a situation in which a user misses a televised valuable scene while the user is operating the software keyboard.

Note that, it is desirable that an aspect ratio does not change before and after setting of the display area. This is because, if the aspect ratio were changed, what is displayed would be disordered and would confuse a user.

Further, the display area can be set by (i) setting in advance display areas of a plurality of sizes (e.g. three levels) and selecting an appropriate size from the plurality of sizes, or (ii) setting any of continuously variable sizes, in accordance with a display size of the character input area 51.

Then, after the software keyboard ends (YES at S6), the display area setting section 31 notifies display information to the display section 21 so that the sub-application is displayed again in accordance with the display area and the display size before the change which display area and the display size are stored in the RAM 33. When the sub-application is displayed again as before the change (S7), processing ends.

Meanwhile, in a case where a plurality of applications are not being displayed in Step S2 (No at S2), the display area setting section 31 notifies the display section 21 of display information for displaying the software keyboard so that the software keyboard is displayed (S8). When the software keyboard having been activated ends (S9), processing ends.

### Embodiment 2

The following discusses another embodiment of the present invention, with reference to FIG. 5. For convenience of explanation, members respectively having identical functions as those described in Embodiment 1 are given the same reference signs, and explanations thereof are omitted.

Some software keyboards change a display position of a software keyboard depending on whether a user uses a left hand or a right hand for operating the software keyboard. In this type of software keyboard, for example, in a case where the user operates the software keyboard with his/her left hand, the display position of the software keyboard is left-aligned in a display section 21. This makes it possible to provide a user-friendly software keyboard.

In Embodiment 2, a display position of a sub-application at the time when the software keyboard is activated is arranged to be on an opposite side with respect to a display position of the software keyboard. Specifically, in a case where the display position of the software keyboard is on the left side, the display position of the sub-application is arranged to be on the right side. Conversely, in a case where the display position of the software keyboard is on the right side, the display position of the sub-application is arranged to be on the left.

FIG. 5 illustrates a display example of Embodiment 2. As illustrated in a right diagram of FIG. 5, in a case where a display position of a software keyboard 52 is left-aligned, a display area of a television 72 is right-aligned in an area on a right side of the software keyboard 52 in which area nothing is displayed.

### Embodiment 3

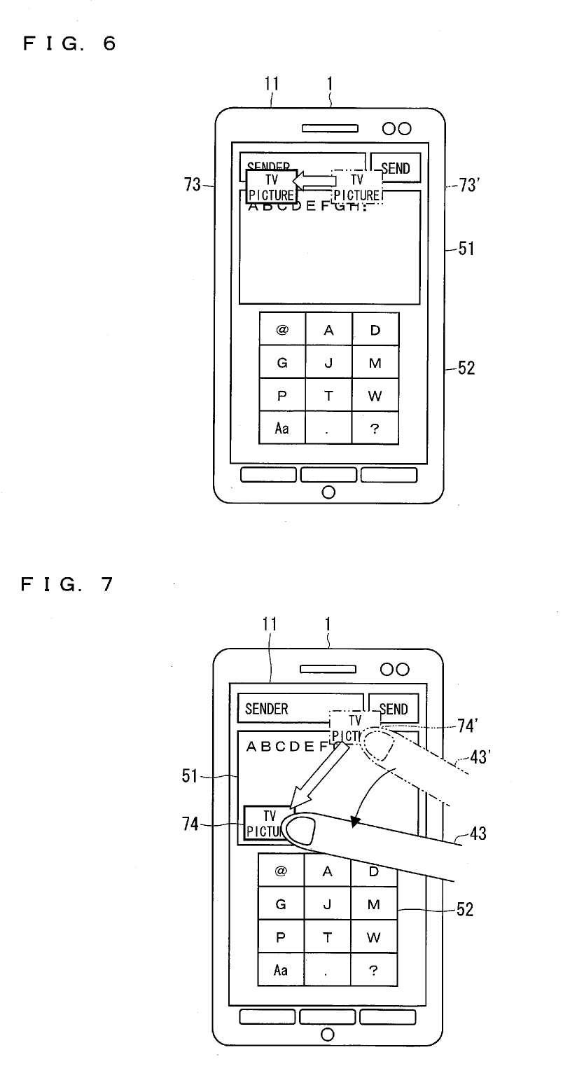

The following discusses Embodiment 3, with reference to FIG. 6. For convenience of explanation, members respectively having identical functions as those described in Embodiments 1 and 2 are given the same reference signs, and explanations thereof are omitted.

In Embodiment 3, in a case where a character input position overlaps with a display area of a sub-application after the display area and a display position of the sub-application are changed, the display position of the sub-application is moved to a position at which the display position of the sub-application does not overlap with the character input position.

The character input position is indicated by a cursor position. In a case where the cursor position or an area over a given number of characters from the cursor position overlaps with the display area of the sub-application, it is possible to carry out processing in which the display area of the sub-application is moved.

The following further discusses an example in which the display area of the sub-application is moved, with reference to FIG. 6. As illustrated in FIG. 6, when a television application display area 73′ overlaps with the cursor position, the television application display area 73′ is moved to a television application display area 73.

This allows a user to recognize characters that are being inputted. This makes it possible to prevent a character input from being disturbed due to overlap of television display with the character input position.

### Modified Example

In Embodiment 3 as described above, a display position of a television application display area can be arranged so as to be movable in accordance with an operation of a user. The display position of the television application display area can be moved by, for example, drugging the television application display area with use of a user's finger or a pen. This makes it possible to place the television application display area at a position that the user desires.

FIG. 7 illustrates an example of moving a display position of a television application display area 74 with a finger 43. In this example of FIG. 7, in accordance with movement in position of a finger from a finger 43′ to the finger 43, a television application display area 74′ is moved in position to the television application display area 74.

### Embodiment 4

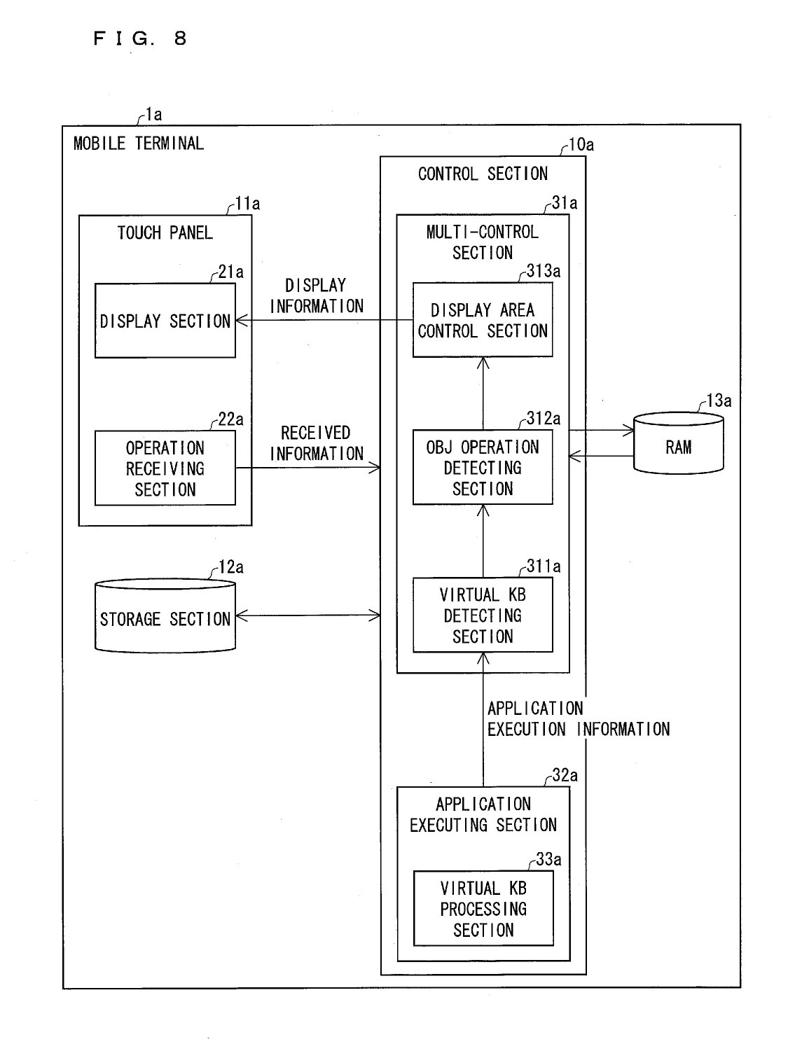

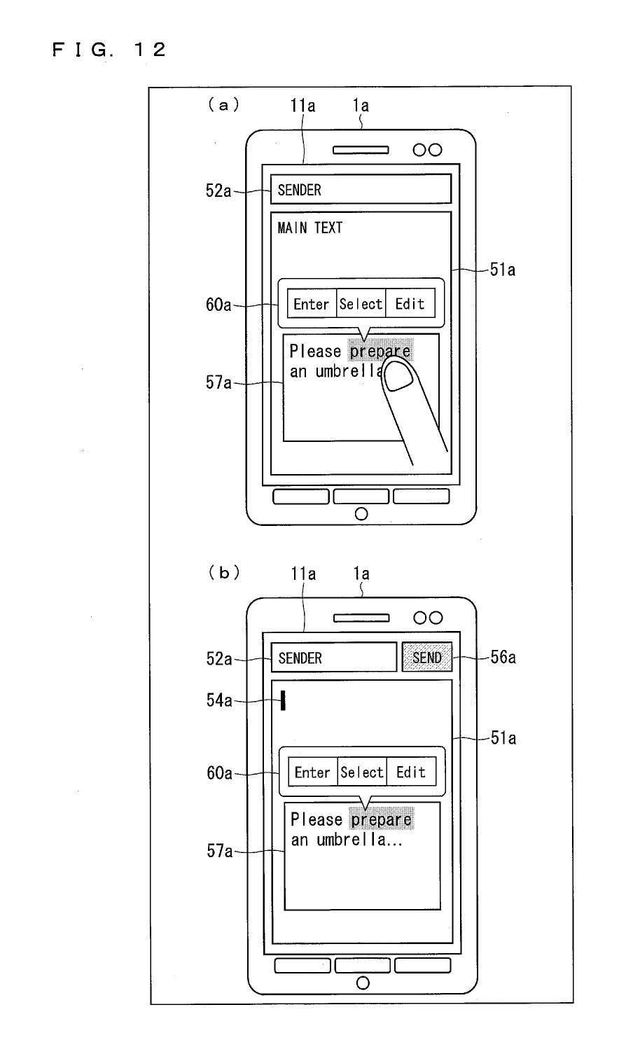

The following discusses a mobile terminal (information terminal) la according to Embodiment 4 of the present invention in detail, with reference to FIGS. 8 to 10, (a) and (b) of FIG. 11.

<Configuration of Device>

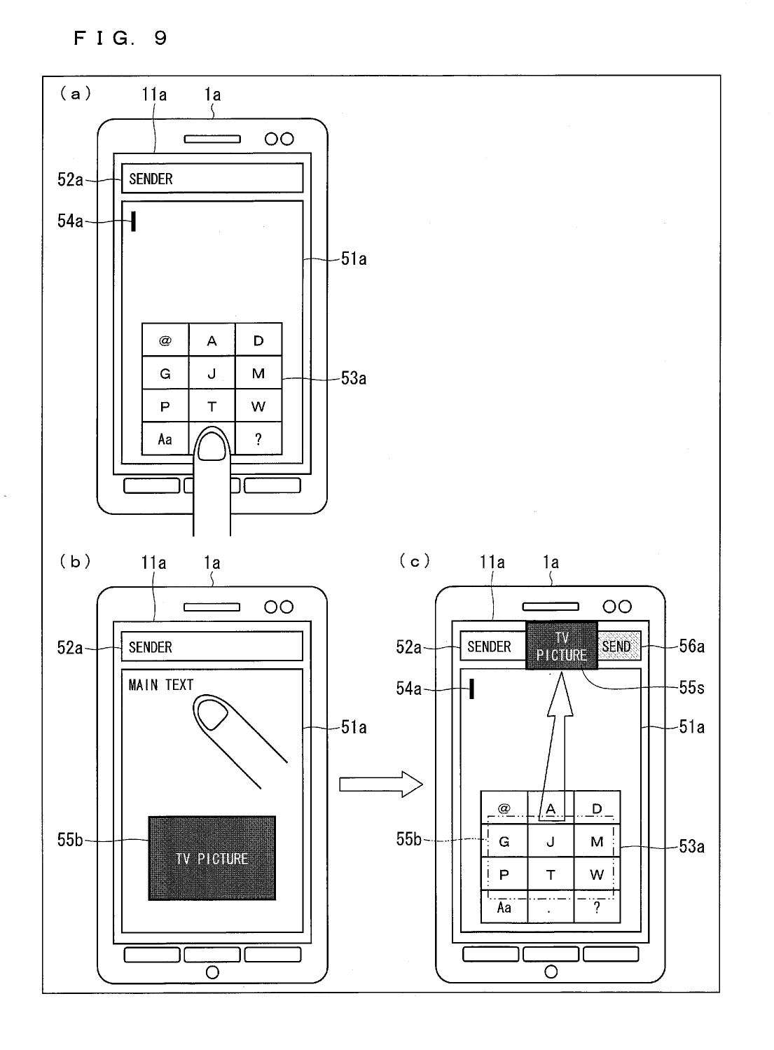

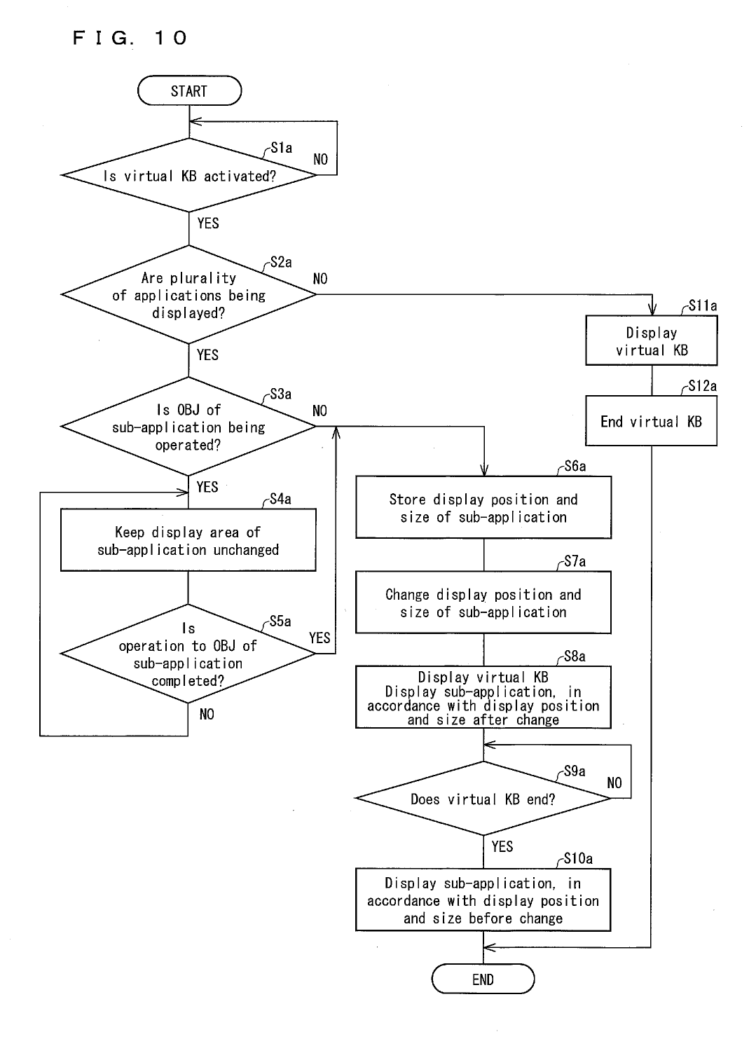

FIG. 9 illustrates an appearance of the mobile terminal 1a according to Embodiment 4. In FIG. 9, the mobile terminal 1a is assumed to be a smartphone.

However, in Embodiment 4, the mobile terminal 1a is not limited to a smartphone but can be, for example, a mobile phone, a laptop PC (personal computer), or the like. As illustrated in (a) of FIG. 9, the mobile terminal 1a includes a touch panel 11a. The mobile terminal 1a is operated by contacting or approaching a finger, a pen, or the like to the touch panel 11a. (a) of FIG. 9 illustrates a state in which (i) a virtual KB (virtual keyboard or virtual software keyboard) 53a is activated and (ii) a text input area 51a and the virtual KB 53a are displayed on the touch panel 11a. The virtual KB displays an image of a keyboard in a display section. Then, when thus displayed keyboard image is touched, the virtual KB carries out, in accordance with a touched position, processing that is the same as processing in a case where a corresponding position of an actual keyboard is depressed.

<Method for Displaying Application in Portion of Display of Another Application in Manner Such that Application is Displayed in Small Size, and Problem Thereof>

The following discusses a method for displaying an application in one portion of a display of another application in a manner such that the application is displayed in small size, and a problem of this method. As illustrated in (a) of FIG. 9, in a case where only a mail application (hereinafter, referred to as a “first application” as appropriate) is activated, (i) the text input area 51a, a sender input area 52a, etc. are displayed in the display section of the mobile terminal 1a and (ii) substantially a lower half on a paper surface of (a) of FIG. 9 of the display section is occupied by the virtual KB. At this time, there is no problem in a character input through the virtual KB. Note that because this state as in (a) of FIG. 9 is a state in which the text input area 51a is being selected (a state in which characters can be inputted), a cursor position 54a is displayed on an upper-left side on a paper surface of (a) of FIG. 9 of the text input area 51a.

Meanwhile, (b) of FIG. 9 illustrates a state in which a plurality of applications including the mail application and a large television application 55b (hereinafter, referred to as a “second application” as appropriate) are displayed (activated). In such a state, for example, when the virtual KB 53a is activated by tapping on the text input area 51a, (i) substantially the lower half of the display section is occupied by the virtual KB and then (ii) the large television application 55b is hidden behind the virtual KB. On this account, as one method to solve such an adverse effect caused by activating (displaying) the virtual KB, the inventors of the present invention have newly devised a method in which a television application is temporarily moved and resized (a display position and a display size are changed) so that the television application does not overlap with the virtual KB itself or a position of the character input through the virtual KB during a character input through the virtual KB. For example, as illustrated in (c) of FIG. 9, a display position and a display size of the large television application 55b is changed to those of a small television application 55s. Then, the small television application 55s is not disturbed by the virtual KB. Therefore, a user can avoid missing any scene of television that the user is watching. Further, the small television application 55s is changed so as not to disturb an operation to the virtual KB. In the mobile terminal (information terminal) la according to Embodiments 4 and 5 described below, the above method is employed as a basic operation.

In the above method, there occurs no problem in a case where the second application is (i) either a television application or a motion picture reproducing application and (ii) intended to view contents such as television contents and motion picture contents. However, in a case where the second application is an application for carrying out various operations other than allowing viewing the above contents, a display area of the application may be changed regardless of a user's intention. This is a non-conventional novel problem which may disturb a user's operation. For example, in a case where the virtual KB of the mail application is activated while a character string is being selected by a text edit application (second application), a change may occur in display position and display size of a display area of the text edit application in which display area the selected character string is displayed. In such a case, the selected character string may be hidden and/or may become so small that it is difficult to read. As a result, an operation to the text edit application may be very difficult,

The following embodiments of the present invention are attained for the purpose of solving the above non-conventional novel problem.

<Schematic Configuration of Mobile Terminal 1a>

Next, the following discusses a schematic configuration of a mobile terminal 1a, with reference to FIG. 8. FIG. 8 is a block diagram illustrating the schematic configuration of the mobile terminal 1a according to Embodiment 4.

As illustrated in FIG. 8, the mobile terminal 1a is configured to include a control section 10a, a touch panel 11a, a storage section 12a, and a RAM 13a. Note that FIG. 8 illustrates a configuration related to multi-display processing for a plurality of applications among various configurations of the mobile terminal 1a. Other configurations of the mobile terminal 1a are the same as those of a conventional mobile terminal, and therefore, descriptions thereof are omitted.

The touch panel 11a includes a display section 21a and an operation receiving section 22a. The display section 21a displays an image on a display screen, in accordance with display information received from the control section 10a. The display section 21a is an LCD (Liquid Crystal Display), an EL (Electroluminescence) display, or the like, and configured to include display elements, and a driver circuit for driving the display elements in accordance with received image data. An example of an input operation to the touch panel 11a encompasses a tap, a double tap, a drug, a flick, a pinch-out, a pinch-in, and the like. The operation receiving section 22a is provided either on the display screen of the display section 21a or integrally formed with the display screen. The operation receiving section 22a receives an operation to the mobile terminal 1a by detecting a position to which a pointer, such as a user's finger or a pen, which indicates a position on the display screen, touches or approaches (hereinafter, referred to simply as a “touch”) on the display screen. The operation receiving section 22a transmits, to the control section 10a, received information that is information on a position where a touch is detected. Note that, in Embodiment 4, an area in which the display section 21a displays an image is the same as an area where the operation receiving section 22a detects an operation.

The control section 10a carries out overall control of each configuration in the mobile terminal 1a, and includes a processor such as a CPU (Central Processing Unit). The storage section 12 stores various data and programs and includes a storage element such as a RAM (Random Access Memory), a ROM (Read Only Memory), a flash memory and/or the like. The RAM 13a is caused to temporarily store a display position, a display size, and the like of a display area that is set by a display area setting section (display control section) 313a of a multi-control section 31a described later. Note that a RAM included in the control section 10a can be used as the RAM 13a. The control section 10a also includes the multi-control section 31a and an application executing section 32a. The multi-control section 31a further includes a virtual KB detecting section (keyboard detecting section) 311a, an OBJ operation detecting section (operation detecting section) 312a, and the display area control section 313a. The application executing section 32a includes a virtual KB processing section 33a. Note that the term “OBJ” is an abbreviation of the term “object” and, in the present specification, used as a generic term for character information (text data such as data of characters and character strings), image information (image data such as data of static images and moving pictures), and display objects and pop-ups that serves as a GUI (Graphical User Interface), and the like. Note that an image as an OBJ can be any type of image and encompasses a thumbnail image etc. Further, the display object serving as a GUI encompasses, for example, an operation object, such as a virtual button and a virtual switch, for receiving a selection which is made by a user.

The virtual KB detecting section 311a detects whether or not a virtual KB is activated by at least one application from among the plurality of applications, by use of the virtual KB processing section 33a of the application executing section 32a.

When the virtual KB detecting section 311a detects that the virtual KB is activated, the OBJ operation detecting section 312a detects whether or not an OBJ is being operated (e.g. character designation, OBJ selection, etc.) by anther application (second application) which is different from the one application (first application) by which the virtual KB is activated. Further, the OBJ operation detecting section 312a is configured to be able to also detect whether or not an operation to the OBJ being operated by the second application is completed.

The following description assumes a case where at least two applications are executed. In such a case, if the display area control section 313a detects, at the time when processing for activating a virtual KB is executed by one (first application) of the applications, that an OBJ is being operated by the other application (second application), the display area control section 313a keeps a display area of the another application unchanged.

Meanwhile, if the display area control section 313a detects, at the time when the processing for activating the virtual KB is carried out by the one application, that no OBJ is being operated by the other application (second application), the display area control section 313a sets a display position and a display size of a display area of the other application so that the operation to the virtual KB is not disturbed. Then, the display area control section 313a transmits display information to the display section 21a so that the other application is displayed in accordance with the set display position and the set display size which are set as above. More specifically, in a case where the display area of the second application is to be changed, the display area control section 313a reduces the display area in size while maintaining an aspect ratio of the display area. Further, the display area control section 313a changes the display position of the second application so that the display position of the second application does not overlap with an area over a given number of characters from a cursor position indicative of a position for displaying text data that is to be inputted through the virtual KB being displayed. Therefore, the second application is displayed so as to overlap with neither the virtual KB nor an area where characters are about to be inputted. This allows preventing an operation to the virtual KB from being disturbed by display of the second application.

Further, the display area control section 313a sets the display position of the second application so that the display of the second application does not overlap with an area where an operation is required immediately after the end of a character input through the virtual KB (e.g. a display area of a display object serving as a GUI such as a virtual button or a virtual key). As a result, the second application is displayed so as not to overlap with the area where an operation is required immediately after the end of a character input. This allows preventing display of the other application from disturbing completion of the operation to the virtual KB by one application.

The display area control section 313a stores, in the RAM 13a, the display position and the display size of the display area of the other application before the above change. Then, when processing of the virtual KB ends (completes), the display area control section 313a transmits display information to the display section 21a so that the other application is displayed in accordance with the display position and the display size before the change. Note that a processing flow for setting the display position and the display size of the display area of the application is described later. Further, the display area control section 313a sets the display position and the display size of the display area of the application in accordance with application execution information that has been obtained from the application executing section 32a. Then, the display area control section 313a transmits, to the display section 21a, information for executing the application which information includes the display area and the display position which are set by the display area control section 313a, as display information.

Furthermore, in a case where the application execution information obtained from the application executing section 32a indicates that a plurality of applications are being executed, the display area control section 313a sets respective display positions and respective display sizes of the applications as appropriate. Then, the display area control section 313a transmits, to the display section 21a, thus set display positions and thus set display sizes as display information. The display area control section 313a also stores, in the RAM 13a, information indicative of the set display positions and the set display sizes. When the OBJ operation detecting section 312a detects that an operation to an OBJ is completed, the display area control section 313a carries out control for changing a display area of a second application so that an operation to a virtual KB is not disturbed. Thereby, in a case where (a) the virtual KB of the first application is activated while the OBJ is being operated by the second application and (b) thereafter, the operation to the OBJ by the second application is completed, the display area of the second application is changed so as not to disturb the operation to the virtual KB. This allows preventing the operation to the virtual KB from being disturbed by display of the second application after completion of the operation to the OBJ of the second application.

The application executing section 32a carries out processing of various applications to be executed in the mobile terminal 1a. The processing of executing the applications can be carried out by a conventional technique, and therefore, a description thereof is omitted. The virtual KB processing section 33a carries out processing related to the virtual KB.

<Processing Flow>

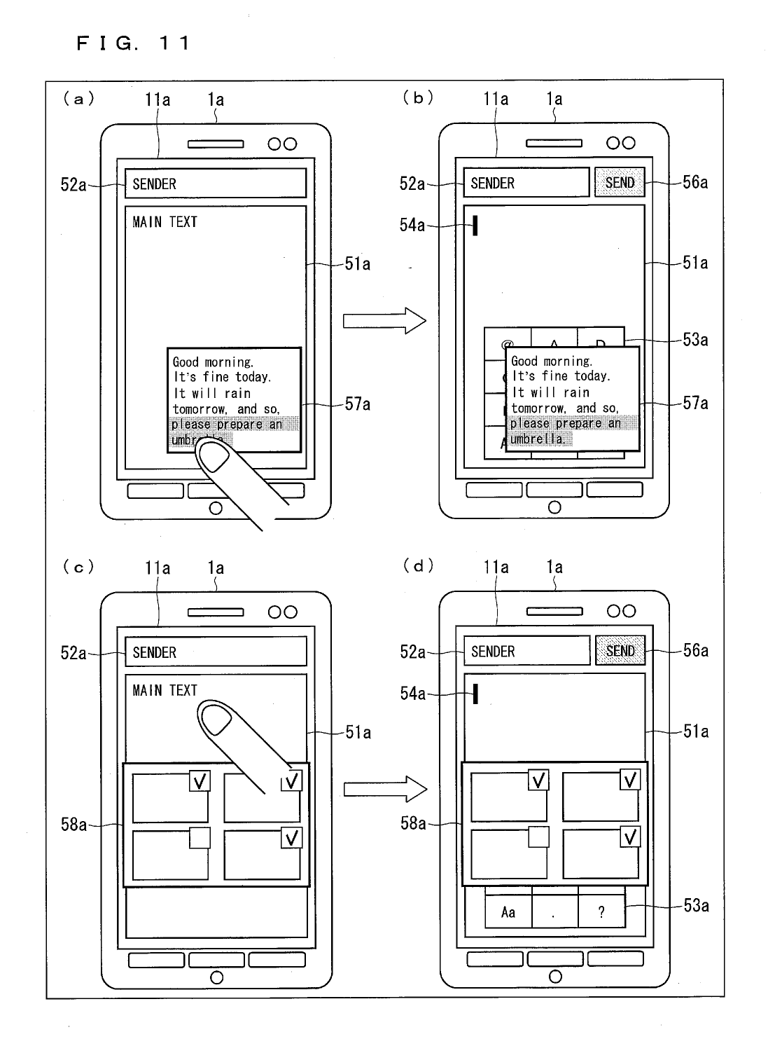

The following (i) first discusses a processing flow for changing a display position and a display size of a display area of a sub-application (second application) in the mobile terminal 1a, and (ii) then discusses a flow in which subsequently, the display position and the display size of the display area of the sub-application are changed or kept unchanged in accordance with a state of the sub-application, with reference to (b) and (c) of FIG. 9, FIG. 10, (a) and (b) of FIG. 11. FIG. 10 is a flowchart illustrating a processing flow in which a display position and a display size of a display area of the sub-application are changed or kept unchanged in accordance with a state of the sub-application. (b) and (c) of FIG. 9 are diagrams illustrating a display example of a case where the display position and the display size of the display area of the sub-application are changed. The “sub-application” as used herein means an application different from an application by which a virtual KB is activated.

As illustrated in (b) of FIG. 9, when a text input area 51a of a mail application (first application) is tapped (selected), a result of such an operation is transmitted, as received information, to the virtual KB processing section 33a of the application executing section 32a via the operation receiving section 22a. Having received the received information, the virtual KB processing section 33a activates the virtual KB. When the virtual KB is activated by the virtual KB processing section 33a, the application executing section 32a transmits, to the virtual KB detecting section 311a of the multi-control section 31a, application execution information (including information indicative of activation of the virtual KB) (hereinafter, referred to as “application execution information”) related to the application that is being executed. The virtual KB is activated, for example, when an instruction to create an email is received in a case where the mail application is activated. For example, as illustrated in (b) of FIG. 9, when the text input area 51a of the mail application is touched with a finger or the like while the mail application and the large television application 55b are concurrently activated, the virtual KB is activated as illustrated in (c) of FIG. 9. When the virtual KB is activated, the text input area 51a and a sender input area 52a are displayed. Concurrently with display of the text input area 51a and the sender input area 52a, a display position of the small television application 55s which is the sub-application is moved to a position that is slightly right to an upper center of the display section 21a. At the same time, the display size of the display area is reduced to substantially a half of an original display area size.

At this time, the display position of the small television application 55s overlaps with neither a character input position in the text input area 51a nor the virtual KB nor a send button 56a (an area where an operation is required immediately after the end of a character input). Further, the display area of the small television application 55s still has a size that does not make it difficult to watch television. Therefore, an operation to the virtual keyboard is not disturbed by television being displayed. This allows a user to concurrently (i) watch television and (ii) operate the virtual keyboard. Accordingly, this allows preventing a situation in which a user misses a televised valuable scene while the user is operating the virtual keyboard. Note that, it is desirable that an aspect ratio does not change before and after setting of the display area. This is because, if the aspect ratio were changed, what is displayed would be disordered and would confuse a user. Further, the display area can be set by (i) setting in advance display areas of a plurality of sizes (e.g. three levels) and selecting an appropriate size from the plurality of sizes, or (ii) setting any of continuously variable sizes, in accordance with a display size of the text input area 51a. Furthermore, an optimum display position and an optimum display size for displaying the television application can be set by a computational processing or the like. The optimum display position and the optimum display size means a position and an area which overlaps with none of (a) the virtual KB, (b) a menu button displayed by an application by which the virtual KB is activated, and (c) a position where characters that will inputted hereafter are to be displayed.

Next, the following discusses a flow in which the display position and the display size of the display area of the second application are kept unchanged or changed in accordance with a state of the second application.

In S1a illustrated in FIG. 10, the virtual KB detecting section 311a determines, based on the application execution information, whether or not a virtual KB is activated by the mail application. In a case where the virtual KB detecting section 311a determines that the virtual KB is activated, the virtual KB detecting section 311a transmits, to the OBJ operation detecting section 312a, such a determination result (hereinafter, referred to as “KB activation application information”; the KB activation application information includes identification information of an application by which the virtual KB is activated) together with the application execution information. Then, the processing step proceeds to S2a (YES). Meanwhile, in a case where none of applications being activated activates a virtual KB, the processing step returns back to S1a (NO).

In S2a, the OBJ operation detecting section 312a having received the KB activation application information and the application execution information determines whether or not a plurality of applications are being displayed (activated). In a case where a plurality of applications are being activated (displayed), the OBJ operation detecting section 312a transmits, to the display area control section 313a, such a determination result (multi-application activation information) together with the application execution information and the KB activation information. Then the processing step proceeds to S3a (YES). Meanwhile, in a case where a plurality of applications are not being displayed, the processing step proceeds to S11a (NO). In S11a, the display area control section 313a causes the virtual KB to be displayed which virtual KB is activated by the mail application. Then, the processing step proceeds to 512a. When the virtual KB ends at 512a, the processing step proceeds to “END”.

In S3a, the OBJ operation detecting section 312a determines whether or not an OBJ is being operated by the sub-application. In a case where the OBJ is being operated, the OBJ operation detecting section 312a transmits such a determination result (information informing that the OBJ is being operated) to the display area control section 313a. Then, the processing step proceeds to S4a (YES). Meanwhile, in a case where the OBJ is not being operated by the sub-application, the OBJ operation detecting section 312a transmits such a determination result (information informing that the OBJ is not being operated) to the display area control section 313a. Then, the processing step proceeds to S6a (YES).

In S4a, the display area control section 313a keeps the display position and the display size of the display area of the sub-application unchanged, and the processing step proceeds to S5a.

In S5a, the OBJ operation detecting section 312a determines whether or not an operation to the OBJ by the sub-application is completed (that is, the OBJ operation detecting section 312a constantly or periodically monitors whether or not the OBJ is being operated by the sub-application). In a case where the OBJ operation detecting section 312a determines that the operation to OBJ by the sub-application is completed, the OBJ operation detecting section 312a transmits such a determination result (which can be OBJ operation completion information, or the above-described information informing that the OBJ is not being operated) to the display area control section 313a. Then, the processing step proceeds to S6a (YES).

Meanwhile, in a case where the OBJ operation detecting section 312a determines that the operation to the OBJ by the sub-application is not completed, the processing step returns back to S4a (NO).

The following discusses a display example of a case where the display position and the display size of the display area of the sub-application are kept unchanged, with reference to (a) and (b) of FIG. 11. In a state illustrated in (a) of FIG. 11, both the mail application and the text edit application 57a are displayed, and a user selects an area of a text “please prepare an umbrella” (one example of a state during an operation to the OBJ; a shaded portion whose area is selected corresponds to the OBJ). When the virtual KB is activated by tapping on the text input area 51a in the above state, the display position and the display size of the text edit application 57a are kept unchanged as illustrated in (b) of FIG. 11 in Embodiment 4. This is because the OBJ is being operated by the text edit application 57a in the above state. At this time, the virtual KB is displayed behind the display area of the text edit application 57a.

In S6a, the display area control section 313a stores, in the RAM 13a, the display position and the display size of the display area of the sub-application. Then, the processing step proceeds to S7a.

In S7a, the virtual KB is displayed, and the display area control section 313a changes the display position and the display size of the display area of the sub-application. Further, the display area control section 313a transmits display information to the display section 21a so that the sub-application is displayed in accordance with the display area and the display size after the change that is made by the display area control section 313a. Then, the processing step proceeds to S8a. In S8a, the virtual KB is displayed in the display section 21a, and the sub-application is displayed in accordance with the display area and the display size after the change. Then, the processing step proceeds to S9a (see (c) of FIG. 9).

When the virtual KB ends in S9a, the processing step proceeds to S10a (YES). Meanwhile, in a case where the virtual keyboard does not end in S9a, the processing step returns back to S9a (NO).

A time at which the virtual keyboard ends can be, for example, a time at which a necessary operation by the sub-application is completed, such as a time after completion of drugging and dropping operations to the OBJ of the sub-application.

In S10a, the display area control section 313a transmits the display information stored in the RAM 13a to the control section 21a so that the sub-application is displayed again in accordance with the display area and the display size before the change. Accordingly, the sub-application is displayed again as before the change. Then, the processing step is ended (END).

According to the mobile terminal 1a as described above, in a case where the virtual KB of the first application is activated while the OBJ is being operated by the second application (e.g. while an OBJ is being selected), the display area of the second application is kept unchanged (a request for changing the display position and the display size of the second application is ignored). Therefore, display of the second application being operated is not disturbed by the virtual KB that is activated. Meanwhile, in a case where the virtual KB of the first application is activated while the OBJ is not being operated by the second application, the display area of the second application is changed so as not to disturb the operation to the virtual KB. Therefore, the operation to the virtual KB is not disturbed by the display of the second application. As a result, it becomes possible to realize an information terminal in which (i) display of an application being operated is not disturbed by a virtual KB and (ii) an operation to the virtual KB is not disturbed by the display of the application.

### Embodiment 5

### Variations of Display Embodiment in Display Section

The following discusses variations of display embodiments in a display section 21a.

### Display Embodiment 1

The following discusses a display embodiment 1 of a display section 21a, with reference to (c) and (d) of FIG. 11.

In a state illustrated in (c) of FIG. 11, both of a mail application and an image edit application 58a are displayed. In the image edit application 58a, a user selects, from among a plurality of displayed images, three images in each of which a check box is checked. When a virtual KB is activated in the above state by tapping on a text input area 51a, an OBJ operation detecting section 312a illustrated in FIG. 8 determines that an OBJ (image) is being operated by the image edit application 58a. As a result, as illustrated in (d) of FIG. 11, a display area control section 313a keeps a display position and a display size of a display area of a text edit application 57a unchanged in an original state in Embodiment 5. At this time, the virtual KB is displayed behind a display area of the image edit application 58a.

### Display Embodiment 2

The following discusses a display embodiment 2 of a display section 21a, with reference to (a) and (b) of FIG. 12. In a state illustrated in (a) of FIG. 12, both of a mail application and a text edit application 57a are displayed. In the text edit application 57a, a user selects a word “prepare” from a text “please prepare an umbrella . . . ”, and as a result, a pop-up 60a asking for a further user's operation is displayed (in (a) of FIG. 12, “Enter”, “Select”, and “Edit” are displayed as operation commands). When a virtual KB is activated in this state by tapping on the text input area 51a, in Embodiment 5, an OBJ operation detecting section 312a illustrated in FIG. 8 keeps a display position and a display size of a display area of a text edit application 57a unchanged in an original state as illustrated in (b) of FIG. 12. This is because an OBJ (the pup-up 60a) is being operated by the text edit application 57a. At this time, the virtual KB is displayed behind the display area of the text edit application 57a.

[Others]

The above embodiments have discussed a television application as an example. However, the present invention is not limited to such a television application, but can be a moving picture reproducing application, a static image displaying application, or an application displaying a text or the like. Note that a moving picture or the like can be downloaded from the internet or taken by a user.

The above embodiments have discussed an example of a case where a software keyboard is displayed. However, the present invention is not limited to such a case, but can be a case where an option menu is displayed with a pop-up or the like.

In the above embodiments, there is no change in size of a display area of the software keyboard between (i) a case where only the software keyboard is displayed and (ii) a case where another application is displayed in addition to the software keyboard. However, the display area of the software keyboard can be reduced in size in a case where another application is displayed.

The above embodiments have discussed an example of a software keyboard on the premise that the software keyboard is for Japanese. However, the software keyboard is not limited to a keyboard for Japanese, but can be a keyboard for English or the like.

### Example Realized by Software

The control sections 10 and 10a of the mobile terminals 1 and 1a (particularly, the display area setting section 31, the multi-control section 31a and the application executing sections 32 and 32a) can be realized a logic circuit (hardware) provided in an integrated circuit (IC chip) or the like or may be realized by software as executed by a CPU (Central Processing Unit).

In the latter case, the mobile terminal 1 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

### CONCLUSION

An information terminal (mobile terminal 1) according to Aspect 1 of the present invention is an information terminal capable of concurrently executing a plurality of applications in a display section, the information terminal including: a software keyboard detecting section (display area setting section 31) for detecting that a software keyboard is activated by a first application in which characters are inputted through the software keyboard; an application determination section (display area setting section 31) for determining whether or not a second application different from the first application is being executed, in a case where the software keyboard detecting section detects that the software keyboard is activated; and an application display control section (display area setting section 31) for changing a display area of the second application so that the display area of the second application does not disturb an operation to the software keyboard, in a case where the application determination section determines that the second application is being executed.

According to the above configuration, a display area of a second application does not disturb an operation to a software keyboard. This configuration allows a user to easily make an operation to the software keyboard. The above configuration also makes it possible to prevent a user from missing what is displayed by the second application, because display of the second application is continued.

The software keyboard is an image of a keyboard displayed in a display section. Then, when thus displayed keyboard image is touched, the software keyboard carries out, in accordance with a touched position, processing that is the same as processing in a case where a corresponding position of an actual keyboard is depressed.

The information terminal according to Aspect 2 of the present invention can be configured such that the application display control section of Aspect 1 (i) reduces a size of the display area of the second application while maintaining an aspect ratio of the display area, and (ii) sets a display position of the second application so that the display position of the second application overlaps with none of (a) the software keyboard being displayed, (b) an area over a given number of characters from a cursor position indicative of a position for displaying a character that is to be inputted through the software keyboard, and (c) an area where an operation is required immediately after an end of a character input.

According to the above configuration, the second application is displayed so as to overlap with none of (a) the keyboard, (b) the area in which characters are about to be inputted, and (c) the area where an operation is required immediately after the end of a character input. This allows reliably preventing an operation to the software keyboard from being disturbed by display of the second application.

The information terminal according to Aspect 3 of the present invention can be configured such that, in the above Aspects 1 or 2, the first application is an email application; and the application display control section aligns the display position of the second application right to a center of the display section on an upper side of the display section, when the information terminal is held by a user so as to have a longitudinal side along a vertical direction.

In many of cases where the software keyboard is activated by the email application, (i) the keyboard is displayed on a lower side of the display section, (ii) the character input area is displayed at the center of the display section, and (iii) the send button is displayed on an upper-right side of the display section. According to the above configuration, because the second application is displayed at a position that is on an upper side and slightly right of the center of the display section, the second application overlaps with none of (a) the displayed keyboard being displayed, (b) a position where a first character is to be inputted in the character input area, and (c) the send button. This allows reliably preventing an operation to the software keyboard from being disturbed while continuing the display of the second application.

The information terminal according to Aspect 4 of the present invention can be configured such that the application display control section of any one of Aspects 1 to 3 causes a portion of the display area of the second application to overlap with a portion of a character input area in which characters are to be inputted through the software keyboard.

The above configuration makes it possible to resize the display area of the second application to a size that makes it easy for a user to view the display area. For example, even in a case where the second application is an application for performing display of television broadcast or reproduction of a moving picture, the user can clearly recognize what is displayed or reproduced.

The information terminal according to Aspect 5 of the present invention can be configured such that the application display control section of any one of Aspects 1 to 4 moves the display position of the second application, in a case where a cursor position and the display area of the second application overlap with each other, the cursor position being indicative of a position for displaying a character that is to be inputted through the software keyboard.

According to the above configuration, it is possible to reliably prevent an operation to the software keyboard from being disturbed while continuing the display of the second application, even in a case where the character input through the software keyboard proceeds and as a result, the character input position and the display area of the second application overlap with each other.

In a virtual keyboard disclosed in Patent Literature 1, there was a problem that display of an application in which an OBJ is being operated is disturbed by a virtual keyboard activated by another application. However, Patent Literature 1 mentions nothing about this problem.

Another object of the present invention is to realize an information terminal capable of preventing display of an application by which an OBJ is being operated from being disturbed due to a virtual keyboard that is activated by another application.

In order to solve the above problem, an information terminal according to Aspect 6 of the present invention includes: a keyboard detecting section (virtual KB detecting section 311a) for detecting that a virtual keyboard (hereinafter, referred to as “virtual KB”) is activated by a first application; an operation detecting section (OBJ operation detecting section 312a) for detecting whether or not an operation to an object (hereinafter, referred to as “OBJ”) is being carried out by a second application that is different from the first application, in a case where the keyboard detecting section detects that the virtual keyboard is activated; and a display control section (display area control section 313a) for carrying out control in which the display area of the second application is kept unchanged, in a case where the operation detecting section detects that the operation to the object is being carried out.

According to the above configuration, when the virtual KB of the first application is activated while the OBJ is being operated by the second application, the display area (display position and display size) of the second application is kept unchanged. Therefore, display of the second application being operated is never disturbed by the activated virtual KB.

The above configuration makes it possible to prevent display of an application by which an OBJ is being operated from being disturbed by a virtual KB which is activated by another application. The “virtual KB” is an image of a keyboard displayed in a display section and, when thus displayed keyboard image is touched, carries out, in accordance with the touched position, processing that is the same as processing in a case where a corresponding portion of an actual keyboard is depressed. In the present specification, the term “OBJ” is used as a generic term for character information (text data), image information (image data), and display objects and pop-ups that serves as a GUI (Graphical User Interface), and the like.

The information terminal according to Aspect 7 can be configured such that, in Aspect 6, the operation detecting section detects whether or not the operation is completed, the operation having been detected by the operation detecting section as being carried out to the object by the second application; and the display control section changes the display area of the second application so that the display area of the second application does not disturb an operation to the virtual keyboard, in a case where the operation detecting section detects that the operation to the object is completed. As a result of this configuration an operation to the virtual keyboard is never disturbed by the display of the second application by which the operation of the OBJ is completed.

The information terminal according to Aspect 8 of the present invention can be configured such that, in Aspect 6 or 7, in a case where the display area of the second application is to be changed, the display control section (i) reduces a size of the display area while maintaining an aspect ratio of the display area and (ii) sets a display position of the second application so that the display position of the second application does not overlap with an area over a given number of characters from a cursor position indicative of a position for displaying text data that is to be inputted through the virtual keyboard being displayed. In this configuration, the second application is displayed so as to overlap with neither the virtual KB nor the area in which characters are about to be inputted. This makes it possible to prevent an operation to the virtual KB from being disturbed by the display of the second application.

The information terminal according to Aspect 9 of the present invention can be configured such that, in any one of Aspects 6 to 8, in a case where the display area of the second application is to be changed, the display control section sets the display position of the second application so that the display position of the second application does not overlap with an area where an operation is required immediately after an end of a character input through the virtual keyboard. In this configuration, the second application is displayed in such a manner that the second application does not overlap with an area (e.g. a display area of a display object serving as a GUI such as a virtual button or a virtual key) where an operation is required immediately after the end of a character input. This makes it possible to prevent completion of the operation to the virtual KB by the first application from being disturbed by the display of the second application.

The information terminal according to any one of the above Aspects can be realized by a computer. In this case, the present invention encompasses (a) a control program for realizing the information terminal by a computer, by causing the computer to function as each of the above sections provided in the information terminal, and (b) a computer-readable storage medium where the control program is stored.

The present invention is not limited to the description of the embodiments above, but may be altered by a skilled person within the scope of the claims. An embodiment based on a proper combination of technical means disclosed in different embodiments is encompassed in the technical scope of the present invention. Further, the technical means disclosed in different embodiments can be combined so as to form a new technical feature.

### INDUSTRIAL APPLICABILITY

The present invention is applicable to an information terminal capable of executing a plurality of applications.

### REFERENCE SIGNS LIST

1, 1a Mobile Terminal (Information Terminal)
11 Touch Panel
21 Display Section
22 Operation Receiving Section
31 Display Area Setting Section (Software Keyboard Detecting Section, Application Determination Section, Display Control Section)
32 Application Executing Section
34 Software Keyboard Processing Section
311a Virtual KB Detecting Section (Keyboard Detecting Section)
312a OBJ Operation Detecting Section (Operation Detecting Section)
313a Display Area Control Section (Display Control Section)
53a Virtual KB (Virtual Keyboard)
54a Cursor Position

1. An information terminal capable of concurrently executing a plurality of applications in a display section, the information terminal comprising:
a software keyboard detecting section for detecting that a software keyboard is activated by a first application in which characters are inputted through the software keyboard;
an application determination section for determining whether or not a second application different from the first application is being executed, in a case where the software keyboard detecting section detects that the software keyboard is activated; and
an application display control section for changing a display area of the second application so that the display area of the second application does not disturb an operation to the software keyboard, in a case where the application determination section determines that the second application is being executed.

2. The information terminal as set forth in claim 1, wherein:
the application display control section (i) reduces a size of the display area of the second application while maintaining an aspect ratio of the display area, and (ii) sets a display position of the second application so that the display position of the second application overlaps with none of (a) the software keyboard being displayed, (b) an area over a given number of characters from a cursor position indicative of a position for displaying a character that is to be inputted through the software keyboard, and (c) an area where an operation is required immediately after an end of a character input.

3. The information terminal as set forth in claim 1, wherein:
the first application is an email application; and
the application display control section aligns the display position of the second application right to a center of the display section on an upper side of the display section, when the information terminal is held by a user so as to have a longitudinal side along a vertical direction.

4. The information terminal as set forth in claim 1, wherein:
the application display control section causes a portion of the display area of the second application to overlap with a portion of a character input area in which characters are to be inputted through the software keyboard.

5. The information terminal as set forth in claim 1, wherein:
the application display control section moves the display position of the second application, in a case where a cursor position and the display area of the second application overlap with each other, the cursor position being indicative of a position for displaying a character that is to be inputted through the software keyboard.

6. An information terminal comprising:
a keyboard detecting section for detecting that a virtual keyboard is activated by a first application;
an operation detecting section for detecting whether or not an operation to an object is being carried out by a second application that is different from the first application, in a case where the keyboard detecting section detects that the virtual keyboard is activated; and
a display control section for carrying out control in which the display area of the second application is kept unchanged, in a case where the operation detecting section detects that the operation to the object is being carried out.

7. The information terminal as set forth in claim 6, wherein:
the operation detecting section detects whether or not the operation is completed, the operation having been detected by the operation detecting section as being carried out to the object by the second application; and
the display control section changes the display area of the second application so that the display area of the second application does not disturb an operation to the virtual keyboard, in a case where the operation detecting section detects that the operation to the object is completed.

8. The information terminal as set forth in claim 6, wherein:
in a case where the display area of the second application is to be changed, the display control section (i) reduces a size of the display area while maintaining an aspect ratio of the display area and (ii) sets a display position of the second application so that the display position of the second application does not overlap with an area over a given number of characters from a cursor position indicative of a position for displaying text data that is to be inputted through the virtual keyboard being displayed.

9. The information terminal as set forth in claim 6, wherein:
in a case where the display area of the second application is to be changed, the display control section sets the display position of the second application so that the display position of the second application does not overlap with an area where an operation is required immediately after an end of a character input through the virtual keyboard.

10. (canceled)
